(19) United States
(12) Patent Application Publication
(10) Pub. No.: US 2025/0205761 A1
(43) Pub. Date: Jun. 26, 2025

(54) METHOD AND SYSTEM FOR RECYCLING THE CONTENTS OF AEROSOL CANS

(71) Applicant: DESPRAY HOLDING B.V., Almelo (NL)

(72) Inventor: Eelco Maarten OSSE, Almelo (NL)

(73) Assignee: DESPRAY HOLDING B.V., Almelo (NL)

(21) Appl. No.: 18/849,087

(22) PCT Filed: Mar. 22, 2023
(86) PCT No.: PCT/EP2023/057310

§ 371 Date: Sep. 20, 2024

(30) Foreign Application Priority Data
Mar. 22, 2022 (NL) 2031367

(51) Int. Cl. B09B 3/40; B09B 3/35; B09B 101/02; B09B 101/10; B65B 69/00

(52) U.S. Cl. CPC B09B 3/40; B09B 3/35; B65B 69/005; B09B 2101/02; B09B 2101/10

(57) ABSTRACT

A method for recycling the contents of aerosol cans, the contents including a liquid. The method includes applying a reduced pressure to at least the liquid, thereby removing a gaseous fraction from the liquid, leaving a liquid fraction, the gaseous fraction containing at least gaseous matter previously dissolved in the liquid fraction, discharging the gaseous fraction separate from the liquid fraction, cooling the gaseous fraction, thereby condensing low-boilers present in the gaseous fraction, and discharging the condensate separately from the remainder of the gaseous fraction. A system for recycling the contents of aerosol cans.

The invention relates to a method for recycling the contents of aerosol cans, the contents comprising a liquid.

A method for recycling the contents of aerosol cans as such is known from WO 2019/216761 A2. In order to separate gas present in the liquid from the liquid, a reduced pressure is applied to the liquid. The liquid and gas are discharged separately. The gas may be used to power turbines for generating power, whereas the liquid may be used e.g. as resources in production processes.

Although the method of WO 2019/216761 A2 has been employed successfully to a certain degree, a need to improve the efficiency of recycling remains.

As such, the invention has as its object to provide a method and system for recycling the contents of aerosol cans, which is more efficient.

Surprisingly, it has been found that the recycling process can be enhanced by adding a step of b) discharging the gaseous fraction separate from the liquid fraction and c. cooling the gaseous fraction, thereby condensing low-boilers present in the gaseous fraction; and d. discharging the condensate separately from the remainder of the gaseous fraction.

By providing the additional cooling step, the low-boilers can be taken out of the gaseous fraction at least partially. It is believed the presence of low-boilers in the gaseous fraction is caused by the reduced pressure in step a). However, the fact that these low-boilers are present in the gaseous fraction and that they cause a problem further downstream in the recycling process, is to the best of applicants knowledge, unknown as of yet. As such, the step of cooling in order to condense low-boilers surprisingly increases the efficiency of the recycling process. In particular, the efficiency is increased since the low-boilers are isolated and can be used as a resource. Moreover, the recycling process becomes more efficient since the low-boilers otherwise still present in the gaseous fraction could damage turbines driven with the gas, which would require maintenance of the turbines more often.

It is noted that it is not strictly necessary to discharge the gaseous and liquid fraction separately, as such, step b) may be dispensed with. As an example, the two fractions may be cooled together, thereby mixing the condensate with the liquid fraction. However, it is advantageous to separate the gaseous and liquid fraction, so that the low-boilers are separated from the liquid fraction without further processing steps.

The aerosol cans may be used or unused. In both cases, aerosols may be present in the cans albeit in varying amounts. Some cans may not contain aerosols.

Low-boilers may herein be defined as a group of materials having a boiling point which is relatively low, for instance lower than other materials in the gaseous fraction. The boiling point may be between −10° C. and 30° C. at ca. −1.0 bar and +0.5 bar measured with respect to atmospheric pressure respectively. . . . The low boilers may include acetone and/or an alcohol. The alcohol may be one or more selected from the group of ethanol, methanol, isopropanol, butanol.

Conversely, the gaseous fraction may comprise any of propane, butane, DME or any mixture thereof.

The liquid fraction may comprise a product to be dispensed with the spray can, such as one or more of paint, hairspray, insecticides, medicine, oils, PU, shaving foam, cosmetics, tan screen, etc.

The method may include a step e) of removing compressed gas from aerosol cans, and allowing the compressed gas to expand.

The method may therefore relate to a method of recycling spray cans including their possibly aerosol contents. Solid materials from the spray cans may be removed from the gaseous and liquid fractions and discharged separately.

In an embodiment, the method further includes performing step c) using cold generated by the compressed gas expanding.

A significant amount of heat may need to be taken away from the gaseous fraction in order to allow the low-boilers to condense. The heat can be taken away efficiently by using cold generated when the gas expands when leaving their respective cans. Since the cans often comprise compressed gas, which thus expands upon leaving the can, cold is generated in the step of removing compressed gas from the aerosol cans. Said cold can be reused advantageously for cooling the gaseous fraction in order to balance the amount of energy needed by the method described herein.

In particular, a closed-loop system may be employed, in which no material is added or removed to the contents of the aerosol cans. Heat may be added or removed from the contents for example by using heat exchangers. As an example, cold extracted from one point may be reused in another, thereby also closing the loop for the extracted cold. Viewed differently, heat added at one point in the system may be extracted from another point of the system, thereby closing the loop for said heat. Such behaviour can suitably be achieved using a closed-loop cooling system, in which a heat transfer medium is circulated and in heat-exchanging contact at at least two points with the contents of the cans, in order to transport heat and/or cold from one point to another. The heat transfer medium may be kept separate from the contents of the cans.

Nevertheless, additional cooling may be advantageous, as will be described further below.

Another embodiment of the method further includes a step f) of compressing the gaseous fraction and optionally the expanded gas.

Compressing the gaseous fraction and optionally the expanded gas may facilitate transport and/or processing the gas.

In order to increase the energy efficiency of the method, cold generated by the compressed gas expanding may be used for cooling the gaseous fraction and optionally the expanded gas during and/or after it has been compressed in step f).

Cold may be transported from the place of expansion to the place of compression using a heat transfer system, for instance a closed-loop heat transfer system comprising at least two heat exchangers and a circulating heat transfer medium.

In step c) it is advantageous to cool both the gaseous fraction and the expanded gas, so that they may be processed more efficiently. The two components may be merged before cooling, thereby simplifying the method. Alternatively, they may be merged during or after cooling.

In another embodiment of the method, the method further comprises discharging the condensate separate from the liquid fraction. Accordingly, the condensed low-boilers can be recycled separately from the liquids relatively easily.

In another embodiment of the method, step a) takes place in a vacuum chamber which is separate from an expansion chamber in which gas from the aerosol cans is expanded.

By applying the reduced pressure in a separate chamber, the conditions of the material in the vacuum chamber can be controlled more accurately. For instance, the temperature and/or pressure may be controlled. In particular, the temperature may be different from that in the expansion chamber, thereby allowing a higher temperature in the vacuum chamber, which may facilitate evaporation. Additionally or alternatively, applying the reduced pressure in a separate chamber allows a relatively elegant construction of especially the expansion chamber.

In another embodiment of the method, step c) takes place in a gas chamber separate from an expansion chamber in which gas from the aerosol cans is expanded and optionally separate from the vacuum chamber if present.

Cooling the gaseous fraction away from the expansion chamber may reduce the amount of material that needs to be cooled, thereby increasing the energy efficiency of the method. Additionally or alternatively, said embodiment may allow (semi-)continuous processing.

In another embodiment of the method, the reduced pressure is at least partially removed before or during step c).

At least partially removing the reduced pressure, i.e. increasing the pressure with respect to the reduced pressure, reduces the minimum temperature needed for condensation. Accordingly, less cooling is needed.

Typically, the pressure may be increased to ambient or slightly above ambient, e.g. 1.1 atm.

In order to at least partially remove the reduced pressure, gas removed in order to apply the reduced pressure of step a) may be used. Accordingly, no or less additional matter may need to be added.

The method may include monitoring the at least partially removed pressure and discharging gas when the pressure exceeds a predetermined threshold. Accordingly, a set pressure level may be limited or maintained.

Discharging may be performed by allowing a compressor to take in gas from the gas chamber, in order to compress it and move it away for further processing or recycling.

In another embodiment of the method, it further includes an additional step g) of cooling the gaseous fraction, to be performed after step c), optionally in a separate vessel, in the presence of trapping elements, thereby trapping pollutants such as water and siloxanes on the trapping elements.

By further cooling the gaseous fraction in the presence of trapping elements, remaining pollutants may be trapped. Surprisingly, it was found that this increases the purity of the resulting gaseous fraction, since the trapping elements can be used to remove e.g. water and siloxanes.

The cooling steps, i.e. steps c) and/or g), may include operating a cooling system. The cooling system may be additional to the heat transfer system introduced, i.e. the cooling system may be separate from the heat transfer system. The cooling system may be configured to discharge heat from to be recycled materials, by cooling them and by discharging, e.g. to the environment, the resulting heat.

The cooling system may extract heat from the to be recycled materials at any point during the method, alone or in combination with the heat transfer system. It may be particularly advantageous when the step c) is performed by the cooling system and the heat transfer system, whereas step g) is performed using only the cooling system. Such a configuration contributes to balancing the energy requirement of the method steps.

In order to recycle aerosol cans in their entirety, the method may further include a step of crushing aerosol cans, thereby releasing their contents. Solid matter may be discharged separately from the liquid and gas fractions, in order to be recycled separately. The crushing may take place in the expansion chamber. The expansion of the contents of the cans causes a cooling which may be used as described above.

The invention also relates to a system for recycling the contents of aerosol cans, the system comprising:
a vacuum chamber having at least one input, for allowing a liquid to be introduced into the vacuum chamber, and at least a first liquid output and a first gas output, for discharging a liquid fraction separately from a gas fraction;
cooling means arranged for cooling the gas fraction coming from the gas output, thereby condensing low-boiler present in the gas fraction; and
a second liquid output for discharging the condensate.

The system may be used for instance to perform the above-described method. The system may thus be configured accordingly, and may bring about the corresponding advantages.

The system may further comprise a gas chamber connected to the first gas output and comprising the second gas output, the cooling means being arranged for cooling gas present in the gas chamber.

The system may further comprise an expansion chamber for allowing compressed gas present in aerosol cans to expand.

The cooling means may comprise a heat exchange system in heat exchanging contact with at least the expansion chamber, in order to heat the expansion chamber and cool the gas fraction. The heat exchange contact may be realized using heat exchangers. The heat exchangers may be connected using a heat transfer medium circulating between the heat exchangers.

In particular, the heat exchange system may comprise at least one conduit at least partially filled with a heat transfer medium, such as a heat exchanging fluid, the medium being in heat exchanging contact with the gas chamber and the gas fraction, for instance via respective heat exchangers. A pump may be present for circulating the heat transfer medium.

Optionally, the heat exchange system also brings about heat exchanging contact between the heat transfer medium and the contents of the gas chamber. The heat exchange system may be configured to cool the contents of the gas chamber and/or the (to be) compressed gas, and at the same time heat the expanded or expanding gas in the expansion chamber.

The heat exchange system may be in heat exchanging contact with the compressor and/or the gas chamber, in order to exchange heat and/or cold between the expansion chamber and the compressor and/or gas chamber.

The system may further include a compressor connected to the second gas output for compressing, and thereby condensing, the remaining gas fraction, the compressor being further connected to a liquid gas collector in order to discharge the condensed remaining gas.

The system may further include a monitoring and control system, wherein the monitoring and control system includes a pressure sensor arranged for sensing a pressure in the gas chamber and a processor operatively connected to the compressor for controlling it, wherein the processor is configured for engaging the compressor when a pressure sensed by the pressure sensor exceeds a predetermined threshold.

The expansion chamber may comprise a third gas output connected to the vacuum chamber. Said third gas output may be configured for letting out gas and introducing it to the gas chamber.

The expansion chamber may comprise a third liquid output, optionally connected to the vacuum chamber. Said third liquid output may be configured for letting out liquid, for instance to the vacuum chamber.

The second liquid output and the first liquid output may discharge separately from each other. Accordingly, the condensate may be discharged separately from the liquid fraction, so that they can be reused effectively.

The system may further include a vacuum system configured for applying a reduced pressure in the vacuum chamber, wherein optionally the vacuum system comprises an output connected to the gas chamber.

The system may further include an additional cooling chamber comprising trapping elements, wherein the system is configured for feeding the gaseous fraction through the additional cooling chamber in order to trap pollutants such as water and siloxanes.

The trapping element may comprise a bulk of separate elements, e.g. spherical or of another shape. The elements may be ceramic.

The system may further include a cooling system configured for extracting heat in order to cool the gas fraction for condensing and/or for trapping pollutants such as water and siloxanes.

The system may further include a crusher configured for crushing spray cans, thereby releasing their contents. The crusher may be arranged in the expansion chamber.

The invention will be further elucidated with reference to the attached figure, wherein:

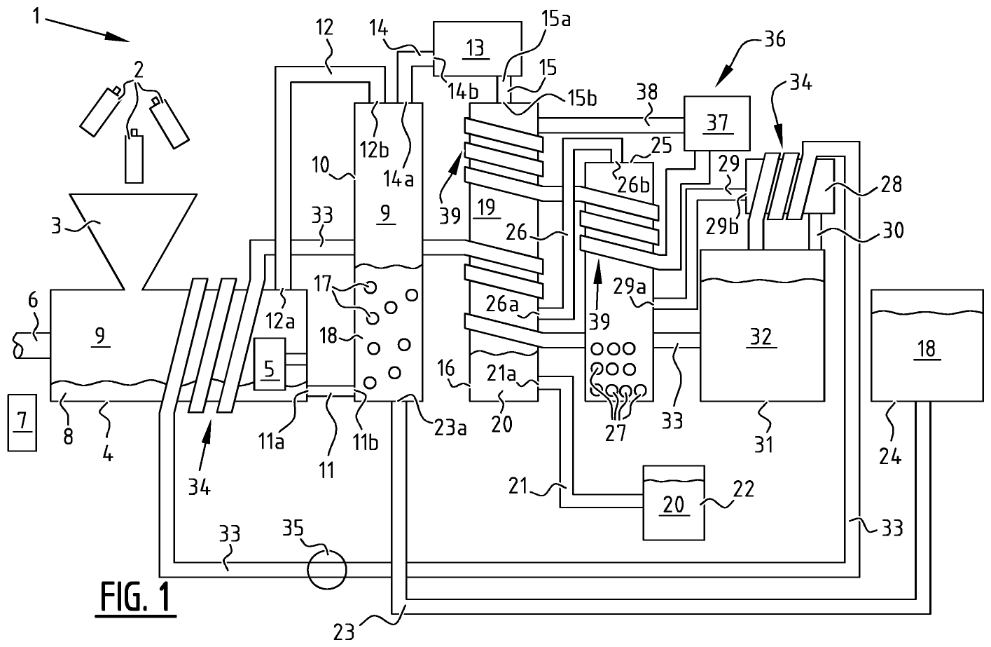

FIG. 1 shows schematically an embodiment of a system for recycling (the contents of) aerosol cans.

FIG. 1 shows a system 1 for recycling aerosol cans 2. The cans 2 can be inserted through a hopper 3 leading into an expansion chamber 4 which includes a ram 5. Movement of the ram 5 crushes the cans 2, thereby releasing their contents. Solid parts, which includes metal, is discharged via an opening 6 in the wall of the expansion chamber 4. As such, solid bricks 7 of recyclable material are obtained. Contents of the cans 2 releases into a liquid 8 and a gas 9. The gas 9, which had been compressed in the cans 2, expands and cools upon being released from the cans 2. The liquid 8 and gas 9 are both fed to a vacuum chamber 10 via respectively a liquid conduit 11 and a gas conduit 12. Both conduits 11, 12 connect outlets (11a, 12a) of the expansion chamber 4 to inlets (11b, 12b) of the vacuum chamber 10. A vacuum system 14 applies a reduced pressure to the vacuum chamber 10 via a vacuum conduit 14 connected to a gas outlet 14a of the vacuum chamber 10. Accordingly, gas is extracted from the vacuum chamber 10 and received at a vacuum system inlet 14b, and later fed via a vacuum system outlet 15a via a conduit 15 to a cooling chamber inlet 15b into a cooling chamber 16. Due to the reduced pressure in the vacuum chamber 10, gas 17 dissolved in a liquid fraction 18 evaporates and joins gas 9 to form a gaseous fraction 19. The gaseous fraction 17 together with gas 9 leaves the vacuum chamber 10 via the vacuum system 13 as a gaseous fraction 19. The gaseous fraction 19 contains evaporated low-boilers, which condense in the cooling chamber to form condensate 20. The condensate 20 is discharged from the cooling chamber 16 through an outlet 21a thereof via a conduit 21 to a container 22 for reuse. Meanwhile, the liquid fraction 18 is discharged from the vacuum chamber 10 via an outlet 23a thereof via a conduit 23 to another container 24 for reuse. The remainder of the gaseous fraction 19 in the cooling chamber 16 is fed to an additional cooling chamber 25 via a conduit 26 connecting a cooling chamber outlet 26a to an inlet 26b of the additional cooling chamber 25. The additional cooling chamber 25 contains ceramic beads 27 which function as trapping elements. Due to its relatively low temperature, pollutants in the gaseous fraction are trapped by the beads 27 and remain in the additional cooling chamber 25. Gaseous fraction 19 with reduced (or removed) pollutants moves further to a compressor 28 which takes in gas 19 at an inlet 29b from a conduit 29 connecting to the additional cooling chamber 25 at an outlet 29a thereof. The compressor 28 discharges compressed gas through a conduit 30 into a container 31. The compressed gas collects as liquified gas 32 in the container 31. The liquefied gas 32 can be reused, for instance for driving turbines.

A heat exchange system is further included, which includes a closed-loop circuit with a conduit 33 interconnecting three heat exchangers 34 which respectively heat the expansion chamber 4 (by taking away cold generated by expanding gas 9) and cool the cooling chamber 16 and the compressor 28 (by taking away heat). Accordingly, cold generated when the gas 9 expands is reused to cool the gas 19 at a later stage in the recycling process. The heat exchange system further includes a pump 35 for circulating a heat exchange medium in the closed-loop conduit 33. The heat exchange medium is for example a fluid or liquid, such as glycol.

An additional cooling system 26 is further included which comprises another conduit 38 feeding to two heat exchangers 39, which are respectively coupled to the cooling chamber 16 and the additional cooling chamber 25. The cooling system further comprises a cooling unit 37 which cools a heat exchange medium, such as a fluid or liquid, such a glycol, in the conduit, circulates it, and vents off heat to the surroundings.

Although the invention has been described above with reference to specific embodiments and examples, the invention is not limited thereto.

As a first example, it is noted the heat transfer system and the cooling system 36 may be used to cool different components than those depicted in FIG. 1. As an alternative to the situation shown in FIG. 1, the cooling chamber 15 may for instance be cooled by only the heat transfer system or by only the cooling system 36. Moreover, the compressor 28 may additionally or alternatively be cooled by the cooling system 36. Finally, the additional cooling chamber 25 may additionally be cooled by the heat transfer system.

As a second example, it is noted that although the heat exchangers 34, 39 are drawn as winding around several components, such as chambers and the compressor, the heat exchangers may be embodied differently. In particular, any heat-exchanging contact between the contents of the respective component may suffice. As such, the winding depiction of the heat exchangers 34, 39 is not to be interpreted restrictively.

As a third example, the embodiment of FIG. 1 shows end products are collected in containers as an example only. In fact, the products may be discharged or collected in any suitable way.

As a fourth example, the presence of the additional cooling chamber 25 is optional. The cooling chamber 16 may connect to the compressor 28 directly.

As such, the invention is also defined by the following claims.

1-33. (canceled)

34. A method for recycling the contents of aerosol cans, the contents comprising a liquid, the method comprising:
a) applying a reduced pressure to at least the liquid, thereby removing a gaseous fraction from the liquid, leaving a liquid fraction, the gaseous fraction containing at least gaseous matter previously dissolved in the liquid fraction;
b) discharging the gaseous fraction separate from the liquid fraction;
c) cooling the gaseous fraction, thereby condensing low-boilers present in the gaseous fraction; and
d) discharging the condensate separately from the remainder of the gaseous fraction.

35. The method according to claim 34, further including:
step e) removing compressed gas from aerosol cans and allowing the compressed gas to expand.

36. The method according to claim 35, further including performing step c) using cold generated by the compressed gas expanding.

37. The method according to claim 34, further including:
step f) compressing the gaseous fraction and optionally the expanded gas.

38. The method according to claim 35, wherein the method further includes step f) compressing the gaseous fraction and optionally the expanded gas, the method further including using cold generated by the compressed gas expanding for cooling the gaseous fraction and optionally the expanded gas during and/or after it has been compressed in step f).

39. The method according to claim 35, wherein the expanded gas and the gaseous fraction are both cooled in step c), optionally by merging them before cooling.

40. The method according to claim 34, further comprising discharging the condensate separate from the liquid fraction.

41. The method according to claim 34,
wherein step a) takes place in a vacuum chamber which is separate from an expansion chamber in which gas from the aerosol cans is expanded, and/or
wherein step c) takes place in a gas chamber separate from an expansion chamber in which gas from the aerosol cans is expanded and separate from the vacuum chamber if present.

42. The method according to claim 34, wherein before or during step c) the reduced pressure is at least partially removed,
wherein optionally gas removed in order to apply the reduced pressure of step a) is used to at least partially remove the reduced pressure in a later step, the method optionally further including monitoring the at least partially removed pressure and discharging gas when the pressure exceeds a predetermined threshold.

43. The method according to claim 34,
wherein the gaseous fraction comprises any one or more of: propane, (iso) butane, DME or any mixture thereof, and/or
wherein the condensate comprises acetone and/or an alcohol, wherein optionally the alcohol is one or more selected from the group of ethanol, methanol, isopropanol, butanol, and/or
wherein the discharged liquid fraction comprises one or more of: paint, hairspray, (the things you want to spray), insecticides, medicine, oils, PU (for foam), shaving foam, cosmetics, tan screen.

44. The method according to claim 34, further including:
an additional step g) of cooling the gaseous fraction, to be performed after step c), optionally in a separate vessel, in the presence of trapping elements, thereby trapping pollutants such as water and siloxanes on the trapping elements, and/or
a step of crushing aerosol cans, thereby releasing their contents.

45. The method according to claim 34, further including operating a cooling system for performing step c) and/or step g).

46. A system for recycling the contents of aerosol cans, the system comprising:
a vacuum chamber having at least one input, for allowing a liquid to be introduced into the vacuum chamber, and at least a first liquid output and a first gas output, for discharging a liquid fraction separately from a gas fraction;
cooling means arranged for cooling the gas fraction coming from the gas output, thereby condensing low-boiler present in the gas fraction; and
a second liquid output for discharging the condensate.

47. The system according to claim 46, further comprising a gas chamber connected to the first gas output and comprising a second gas output, the cooling means being arranged for cooling gas present in the gas chamber.

48. The system according to claim 46, further comprising an expansion chamber for allowing compressed gas present in aerosol cans to expand,
wherein optionally the cooling means comprise a heat exchange system in heat exchanging contact with at least the expansion chamber, in order to heat the expansion chamber and cool the gas fraction, wherein optionally the heat exchange system comprises at least one conduit at least partially filled with a heat exchanging fluid, the fluid being in heat exchanging contact with the gas chamber and the gas fraction, for instance via respective heat exchangers.

49. The system according to claim 46, further including a compressor connected to the second gas output for compressing, and thereby condensing, the remaining gas fraction, the compressor being further connected to a liquid gas collector in order to discharge the condensed remaining gas,
the system optionally further including a monitoring and control system, wherein the monitoring and control system includes a pressure sensor arranged for sensing a pressure in the gas chamber and a processor operatively connected to the compressor for controlling it, wherein the processor is configured for engaging the compressor when a pressure sensed by the pressure sensor exceeds a predetermined threshold.

50. The system according to claim 49, the system comprising the heat exchange system in heat exchanging contact with at least the expansion chamber, wherein the heat exchange system is further in heat exchanging contact with the compressor and/or the gas chamber, in order to exchange heat and/or cold between the expansion chamber and the compressor and/or gas chamber.

51. The system according to claim 48, the expansion chamber comprising:
a third gas output connected to the vacuum chamber, and/or
a third liquid output, optionally connected to the vacuum chamber.

52. The system according to claim 46, wherein the second liquid output and the first liquid output discharge separately from each other.

53. The system according to claim 46, further including:
a vacuum system configured for applying a reduced pressure in the vacuum chamber, wherein optionally the vacuum system comprises an output connected to the gas chamber, and/or
an additional cooling chamber comprising trapping elements, wherein the system is configured for feeding the gaseous fraction through the additional cooling chamber in order to trap pollutants such as water and siloxanes, and/or
a cooling system configured for extracting heat for cooling the gas fraction for condensing and/or for trapping pollutants such as water and siloxanes, and/or
a crusher configured for crushing spray cans, thereby releasing their contents.
